(19) United States
(12) Patent Application Publication
(10) Pub. No.: US 2017/0197284 A1
(43) Pub. Date: Jul. 13, 2017

(54) METHOD FOR REMOVING PARTIALLY SINTERED POWDER FROM INTERNAL PASSAGES IN ELECTRON BEAM ADDITIVE MANUFACTURED PARTS

(71) Applicant: United Technologies Corporation, Hartford, CT (US)

(72) Inventors: Wendell V. Twelves, JR., Glastonbury, CT (US); Evan Butcher, Manchester, CT (US); John P. Rizzo, JR., Vernon, CT (US)

(21) Appl. No.: 14/994,351

(22) Filed: Jan. 13, 2016

(51) Int. Cl. B23P 15/02

(52) U.S. Cl. CPC B23P 15/02

(57) ABSTRACT

A method of removing partially sintered powder from an internal passage in a metal component formed by electron beam additive manufacturing (EBAM) includes co-forming a solid wire cutter in the passage during the EBAM forming process and removing partially sintered powder from the cavity by extracting the cutter from the cavity.

### BACKGROUND

This invention relates to fluid passageways in gas turbine engines. In particular the invention relates to fluid passageways such as lightweight metal ducts formed by electron beam additive manufacturing (EBAM).

Gas turbine engines typically include a compressor section to pressurize airflow, a combustor section to burn a hydrocarbon fuel in the presence of the pressurized air, and a turbine section to extract energy from the resultant combusting gasses.

In the gas turbine industry, methods for fabricating components with internal passageways such as blades and vanes in the turbine section and fluid ducts in other sections such as bleed-air systems and lubrication systems using additive manufacturing invite significant attention. Since a component is produced in a continuous process in an additive manufacturing operation, features associated with conventional manufacturing processes such as machining, forging, welding, casting, etc. can be eliminated leading to savings in weight, cost, material and time.

An inherent feature of metallic components with internal passageways fabricated by powder based additive manufacturing is that removal of partially sintered powder in completed fused passageways following fabrication may be an issue.

### SUMMARY

A method of removing partially sintered powder from an internal passage in a metal component formed by electron beam additive manufacturing (EBAM) includes co-forming a solid wire cutter in the passage during the EBAM forming process and removing partially sintered powder from the cavity by extracting the cutter from the cavity.

In an embodiment a cutter for removing partially sintered powder from an internal passage in a metal component formed by electron beam additive manufacturing (EBAM) consists of a solid wire in the form of a helical coil with a radial shape that conforms to, but is not attached to, the interior of the passage such that as the coil straightens out during extraction, the wire shears interparticle bonds in the sintered powder allowing the powder to be removed from the passage along with the cutter.

### BRIEF DESCRIPTION OF THE DRAWINGS

FIG. 1 is a schematic view of an example gas turbine engine.

FIG. 2 is a flow diagram of an electron beam additive manufacturing process.

FIG. 3 is a schematic view of a representative electron beam additive manufacturing process.

FIGS. 4A and 4B are schematic views before and during powder removal of the invention.

### DETAILED DESCRIPTION

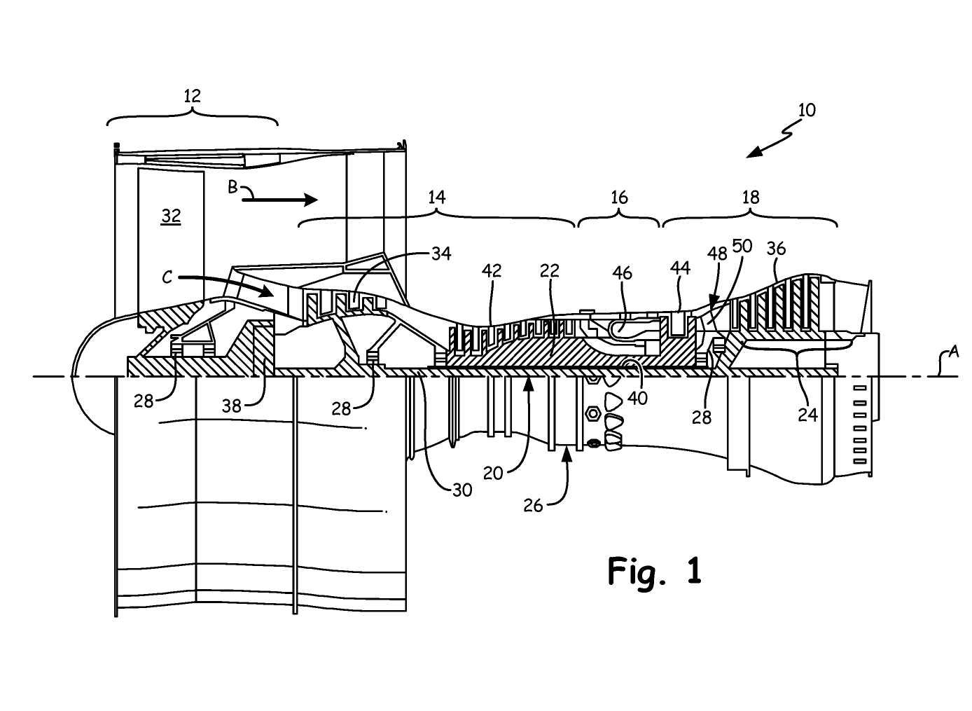

FIG. 1 schematically illustrates an example gas turbine engine 10 that includes fan section 12, compressor section 14, combustor section 16 and turbine section 18. Fan section 12 drives air along bypass flow path B while compressor section 14 draws air in along core flow path C where air is compressed and communicated to combustor section 16. In combustor section 16, air is mixed with fuel and ignited to generate a high pressure exhaust gas stream that expands through turbine section 18 where energy is extracted and utilized to drive fan section 12 and compressor section 14.

Example engine 10 generally includes low speed spool 20 and high speed spool 22 mounted for rotation about an engine central longitudinal axis A relative to engine static structure 26 via several bearing systems 28. It should be understood that various bearing systems 28 and various locations may alternatively or additionally be provided.

Low speed spool 20 generally includes inner shaft 30 that connects fan 32 and low pressure (or first) compressor section 34 to low pressure (or first) turbine section 36. Inner shaft 30 drives fan 32 through a speed change device, such as geared architecture 38, to drive fan 32 at a lower speed than the low speed spool 20. High speed spool 22 includes outer shaft 40 that interconnects high pressure (or second) compressor section 42 and high pressure (or second) turbine section 44. Inner shaft 30 and outer shaft 40 are concentric and rotate via bearing system 28 about engine central longitudinal axis A.

Combustor 46 is arranged between high pressure compressor 42 and high pressure turbine 44. In one example, high pressure turbine 44 includes at least two stages to provide a double stage high pressure turbine 44. In another example high pressure turbine 44 includes only a single stage. As used herein, a “high pressure” compressor or turbine experiences a higher pressure than a corresponding “low pressure” compressor or turbine.

Mid turbine frame 48 of engine static structure 26 is arranged generally between high pressure turbine 44 and low pressure turbine 36. Mid frame 48 further supports bearing systems 28 and turbine section 18 as well as directing airflow entering low pressure turbine 36.

Airflow through core flow path C is compressed by low pressure compressor 34 then by high pressure compressor 42 mixed with fuel and ignited in combustor 46 to produce high speed exhaust gases that are then expanded through high pressure turbine 44 and low pressure turbine 36. Mid turbine frame 48 includes vanes 50 which are in the core airflow path and function as an inlet guide vane for low pressure turbine 36. Utilizing vane 50 of mid turbine frame 48 as inlet guide vane for low pressure turbine 36 decreases the length of low pressure turbine 36 without increasing the axial length of mid turbine frame 48. Reducing or eliminating the number of vanes in low pressure turbine 36 shortens the axial length of turbine section 18. Thus the compactness of gas turbine engine 10 is increased and a higher power density may be achieved.

The example bleed air system discussed here is described in commonly owned U.S. Patent Application Publication No. 2014/0165588 to Snape et al., which is incorporated herein by reference in its entirety.

The example describes a plurality of bleed air outlets and associated duct work as well as heat exchanger components with internal passages connected to high pressure compressor 42 that, when fabricated by electron beam additive manufacturing (EBAM), are faced with issues of removing sintered powder from the passages following fabrication. A method for removing the sintered powder from these passages is described below.

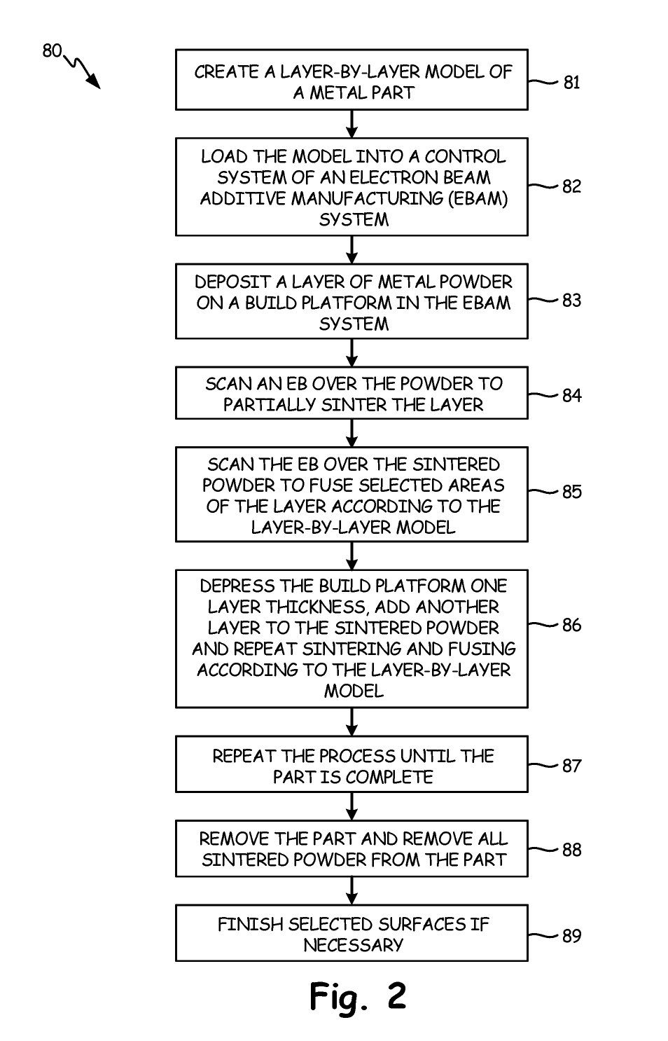

The electron beam additive manufacturing (EBAM) process for forming components having internal passages is discussed in commonly owned U.S. Patent Application Publication No. 2014/0169981 to Bales et al., which is incorporated herein by reference in its entirety. EBAM process 80 is shown in FIG. 2. In the first step, a digital layer by layer model of a metal part is created (step 81). In the next step, the model is loaded into the control system of an EBAM manufacturing system (step 82). A single layer of metal powder with a diameter of from about 20 microns to about 100 microns having the desired alloy composition is deposited on a build platform in the EBAM system (step 83). A focused electron beam (EB) is then scanned over the entire build platform to partially sinter the layer (step 84). In the next step, the EB is scanned over the sintered powder, typically at a slower rate to fuse portions of the layer that form a solid portion of the final product according to the layer by layer model of the product (step 85). In the build process, the build platform is then indexed down by one powder layer thickness. Another layer of powder is added and the sintering and fusing operations are repeated (step 86). The step by step process is repeated until the part is complete (step 87). The part is then removed from the EBAM manufacturing system and the partially sintered, unfused powder is removed from the part (step 88). If necessary, selected surfaces are mechanically finished to produce a final part (step 89).

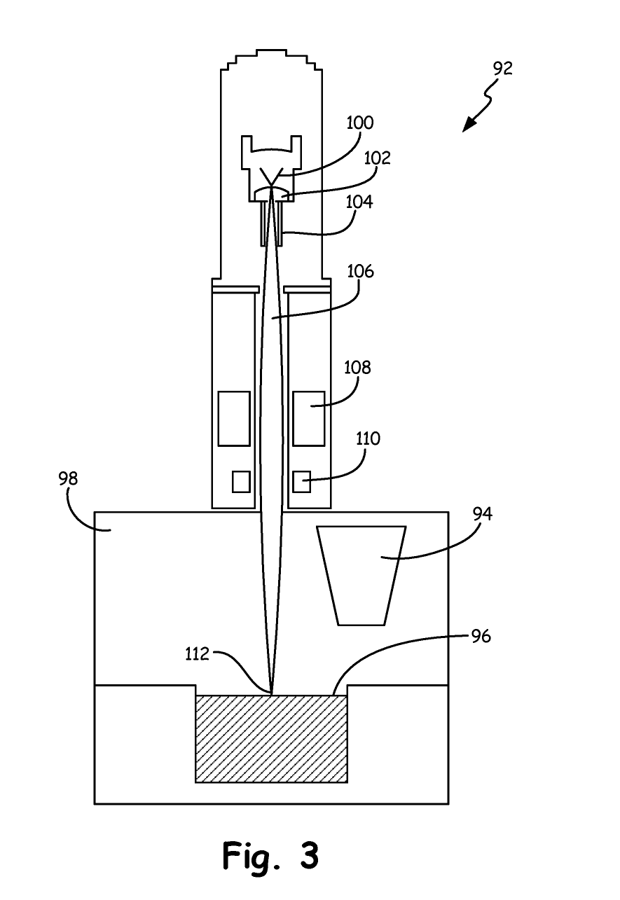

FIG. 3 is a diagram illustrating EBAM system 92 used to form parts having internal passages. Alloy powder is held in powder supply 94 and powder is deposited on build table 96 in vacuum chamber 98. Filament 100, grid cup 102 and anode 104 create electron beam 106, which passes through focus coil 108 and is directed by deflection coil 110 to strike selected areas of the powder layer on build table 96 at position 112. Beam 106 moves based on a predetermined two dimensional pattern from the digital file. Once the pattern is complete for one layer, a next layer of powder and a new two dimensional pattern are subjected to the same treatment until all the patterns have been applied. Build table 96 is designed to be lowered by the thickness of the alloy powder layer after each pass. As noted above, powder may have an average diameter of from about 20 microns to about 100 microns, though other powder sizes may be used. The component being built may be made of a nickel base alloy, cobalt base alloy, iron base alloy, titanium base alloy, aluminum base alloy, copper base alloy, or mixtures thereof.

As noted above, with EBAM additive manufacturing, there are two forms of metal in a finished part. One form is the solid fused alloy product itself. The other form is partially sintered alloy powder that is sintered to the degree where it forms a frangible, but solid powder structure that will not flow freely under the influence of gravity. A sufficient number of interparticle bonds must be broken in order for the unfused powder to be removed from the finished part. Typically, an abrasive grit blast process using matching metal powder is used to remove the partially sintered powder from external surfaces and shallow recesses of an EBAM manufactured part. Removal of partially sintered powder from internal chambers and non-line of sight passages remains a problem in EBAM structures.

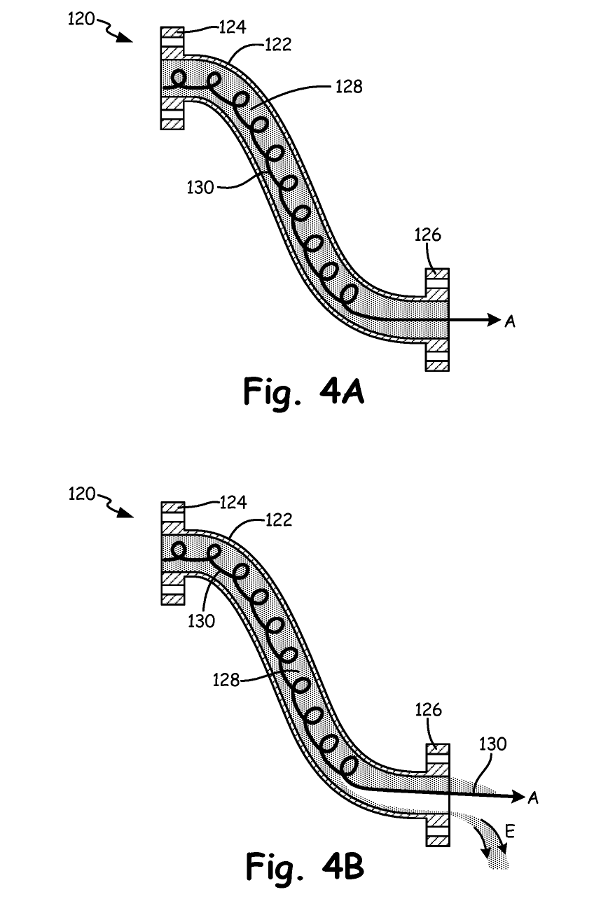

FIGS. 4A and 4B are diagrams illustrating a process by which the above-mentioned difficult-to-remove partially sintered powder can be removed from internal passages and chambers. FIG. 4A is a schematic view of a cross-section of metal duct 120 fabricated by EBAM. Metal duct 120 comprises solid wall 122 and solid end flanges 124 and 126. The interior of duct 120 is filled with partially sintered alloy powder 128 and helical wire cutter 130. Helical wire cutter 130 is co-grown in the interior of duct 120 during EBAM manufacturing of duct 120—that is, the digital layer by layer model of the metal part, including metal duct 120, includes a layer by layer model of helical wire cutter 130 so that the structure of helical wire cutter 130 is formed inside metal duct 120 during the EBAM process. The diameter of wire cutter 130 may be from about 0.020 inches (0.51 mm) to about 0.25 inches (6.35 mm). In a particular embodiment, the diameter of wire cutter 130 may be from about 0.060 inches (1.52 mm) to about 0.125 inches (3.18 mm). In various embodiments, wire cutter 130 may be a helix with a radial shape of a circle, oval, square, or triangle, for example. To effect removal of partially sintered powder 128 from duct 120, wire cutter 130 is pulled in the direction of arrow A to extract wire cutter 130 from duct 120. In order to aid extraction, the end of wire cutter 130 may have a gripping element such as a loop, ball, threads, or another gripping element known in the art.

As wire cutter 130 is extracted from duct 120, the coils of wire cutter 130 straighten. Straightening of wire cutter 130 imparts a localized shearing action on partially sintered powder 128, thereby separating weak interparticle bonds in the powder in the region near end flange 126, which causes the powder to be ejected from duct 120 as schematically indicated by arrows E as shown in FIG. 4B. Removal of the partially sintered powder from the cavity may be assisted by orienting the part to enable gravity, vibration, and air jet or fluid jet.

In an embodiment, partially sintered powder extraction by the present invention may be improved by nesting multiple helical wire cutters inside one another. This may be useful in passages with larger cross-sections. While the invention discloses a method to remove partially sintered powder from a narrow passage, assemblies of wire cutters arranged in large inaccessible inner chambers may also be formed to perform the same function.

### Discussion of Possible Embodiments

The following are non-exclusive descriptions of possible embodiments of the present invention.

A method of removing partially sintered powder from an internal passage in a metal component formed by electron beam additive manufacturing (EBAM) includes: co-forming a solid wire cutter in the passage during EBAM formation of the metal component; and removing partially sintered powder from the passage by extracting the solid wire cutter from the passage.

The method of preceding paragraph can optionally include, additionally and/or alternatively any, one or more of the following features, configurations and/or additional components:

Extracting the solid wire cutter from the passage includes gripping an end of the solid wire cutter and pulling it out of the passage.

The solid wire cutter is a helical coil with a radial shape that conforms to the interior of the passage such that as the wire coil straightens during extraction, the solid wire cutter shears interparticle bonds in the partially sintered powder.

The end of the solid wire cutter may include a gripping element such as a loop, a ball, or threads.

The radial shape may be a circle, oval, square, or triangle.

The cutter may be nested helical coils.

The cutter may be assemblies of wire cutters arranged in a large inaccessible chamber in the metal component.

The metal component may be a nickel base alloy, cobalt base alloy, iron base alloy, titanium base alloy, aluminum base alloy, copper base alloy, or mixtures thereof.

The solid wire diameter may be from about 0.020 inches (0.51 mm) to about 0.25 inches (6.35 mm).

The solid wire diameter may be from about 0.060 inches (1.52 mm) to about 0.125 inches (3.18 mm).

A cutter configured to remove partially sintered powder from an internal passage in a metal component formed by electron beam additive manufacturing (EBAM) includes: a solid wire formed inside the passage by the EBAM process, where the solid wire may be a helical coil with a radial shape that conforms to the interior of the passage and may be configured and arranged for the solid wire to shear interparticle bonds in the partially sintered powder in response to the coil straightening during extraction from the passage causing the partially sintered powder to be removed from the passage.

The cutter of the preceding paragraph can optionally include, additionally and/or alternatively any, one or more of the following features, configurations, and/or additional components:

The cutter may be configured such that extraction from the passage is performed by gripping an end of the solid wire and pulling the solid wire out of the passage.

The end of the solid wire may include a gripping element such as a loop, a ball, or threads.

The radial shape may be a circle, oval, square, or triangle.

The metal component may be a nickel base alloy, cobalt base alloy, iron base alloy, titanium base alloy, aluminum base alloy, copper base alloy, or mixtures thereof.

The solid wire may have a diameter of from about 0.020 inches (0.51 mm) to about 0.25 inches (6.35 mm).

The solid wire may have a diameter of from about 0.060 inches (1.52 mm) to about 0.125 inches (3.18 mm).

The cutter may be nested helical coils.

The metal component may be a gas turbine engine component.

The gas turbine engine component may be a heat exchanger, bleed air system, or lubrication system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of removing partially sintered powder from an internal passage in a metal component formed by electron beam additive manufacturing (EBAM) comprising:
co-forming a solid wire cutter in the passage during EBAM formation of the metal component; and
removing partially sintered powder from the passage by extracting the solid wire cutter from the passage.

2. The method of claim 1, wherein extracting the solid wire cutter from the passage comprises gripping an end of the solid wire cutter and pulling it out of the passage.

3. The method of claim 1, wherein the solid wire cutter is a helical coil with a radial shape that conforms to an interior of the passage such that as the wire coil straightens during extraction, the solid wire cutter shears interparticle bonds in the partially sintered powder.

4. The method of claim 3, wherein an end of the solid wire cutter includes a gripping element comprising a loop, a ball, or threads.

5. The method of claim 3, wherein the radial shape comprises a circle, oval, square, or triangle.

6. The method of claim 3, wherein the cutter comprises nested helical coils.

7. The method of claim 3, wherein the cutter comprises assemblies of wire cutters arranged in a large inaccessible chamber in the metal component.

8. The method of claim 1, wherein the metal component is made of a nickel base alloy, cobalt base alloy, iron base alloy, titanium base alloy, aluminum base alloy, copper base alloy, or mixtures thereof.

9. The method of claim 1, wherein the solid wire diameter is from about 0.020 inches (0.51 mm) to about 0.25 inches (6.35 mm).

10. The method of claim 9, wherein the solid wire diameter is from about 0.060 inches (1.52 mm) to about 0.125 inches (3.18 mm).

11. A cutter configured to remove partially sintered powder from an internal passage in a metal component formed by electron beam additive manufacturing (EBAM), comprising:
a solid wire formed inside the passage by the EBAM process, the solid wire being a helical coil with a radial shape that conforms to an interior of the passage, configured and arranged so the solid wire shears interparticle bonds in the partially sintered powder in response to straightening of the coil during extraction from the passage, causing the partially sintered powder to be removed from the passage.

12. The cutter of claim 11, wherein the cutter is configured such that extraction from the passage is performed by gripping an end of the solid wire and pulling the solid wire out of the passage.

13. The cutter of claim 12, wherein the end of the solid wire includes a gripping element comprising a loop, a ball, or threads.

14. The cutter of claim 11, wherein the radial shape comprises a circle, oval, square, or triangle.

15. The cutter of claim 11 wherein the metal component is made of a nickel base alloy, cobalt base alloy, iron base alloy, titanium base alloy, aluminum base alloy, copper base alloy, or mixtures thereof.

16. The cutter of claim 11, wherein the solid wire has a diameter of from about 0.020 inches (0.51 mm) to about 0.25 inches (6.35 mm).

17. The cutter of claim 11, wherein the solid wire has a diameter of from about 0.060 inches (1.52 mm) to about 0.125 inches (3.18 mm).

18. The cutter of claim 11, wherein the cutter comprises nested helical coils.

19. The cutter of claim 11, wherein the metal component comprises a gas turbine engine component.

20. The cutter of claim 19, wherein the gas turbine engine component is one of a heat exchanger, bleed air system, or lubrication system.
